(19) United States
(12) Patent Application Publication
(10) Pub. No.: US 2014/0226784 A1
(43) Pub. Date: Aug. 14, 2014

(54) METHOD AND APPARATUS FOR CAPTURING IMAGES OF A TARGET OBJECT

(71) Applicant: THE BOARD OF TRUSTEES OF THE UNIVERSITY OF ILLINOIS, Urbana, IL (US)

(72) Inventor: Ling Jian Meng, Champaign, IL (US)

(73) Assignee: THE BOARD OF TRUSTEES OF THE UNIVERSITY OF ILLINOIS, Urbana, IL (US)

(21) Appl. No.: 14/175,206

(22) Filed: Feb. 7, 2014

Related U.S. Application Data
(60) Provisional application No. 61/764,760, filed on Feb. 14, 2013.
(60) Provisional application No. 61/894,952, filed on Oct. 24, 2013.

(51) Int. Cl. G01N 23/04

(52) U.S. Cl. CPC G01N 23/046
USPC 378/19; 29/428

(57) ABSTRACT

Aspects of the subject disclosure may include, for example, a method for receiving, from each panel of a plurality of panels positioned at differing viewing angles of a target object, a plurality of two-dimensional (2D) projections from fractional views of a volume of interest of the target object, wherein the plurality of 2D projections of fractional views provided by each panel are generated from a plurality of apertures and corresponding plurality of sensors used by each panel to sense gamma rays generated by the target object, and generating, from the plurality of 2D projections of the fractional views, a three-dimensional (3D) image of a 3D section of the target object. Other embodiments are disclosed.

### PRIOR APPLICATION

The present application claims the benefit of priority to U.S. Provisional Application No. 61/764,760 filed on Feb. 14, 2013, which is hereby incorporated herein by reference in its entirety. The present application also claims the benefit of priority to U.S. Provisional Application No. 61/894,952 filed on Oct. 24, 2013, which is also hereby incorporated herein by reference in its entirety.

### FIELD OF THE DISCLOSURE

The subject disclosure relates to a method and apparatus for capturing images of a target object.

### BACKGROUND

A Single-Photon Emission Computed Tomography (SPECT) is an imaging technique using gamma rays to capture three-dimensional (3D) information of a target object. Improving sensitivity of imaging systems such as a SPECT system is desirable.

### BRIEF DESCRIPTION OF THE DRAWINGS

Reference will now be made to the accompanying drawings, which are not necessarily drawn to scale, and wherein:

FIG. 1 depicts an illustrative embodiment of a nature apposition compound eye and an inverted compound eye (ICE) camera. (A) Head of a fruit fly ‘Drosophila melanogaster’. (B) Refracting superposition compound eye. A large number of corneal facets and bullet-shaped crystalline cones collect and focus light—across the clear zone of the eye (cz)—towards single photoreceptors in the retina. Several hundred, or even thousands, of facets service a single photoreceptor. Not surprisingly, many nocturnal arthropods have refracting superposition eyes, and benefit from the significant improvement in sensitivity. (C) Focal apposition compound eye. Light reaches the photoreceptors exclusively from the small corneal lens located directly above. This eye design is typical of day-active insects. (D) Schematic of a superposition ICE camera based on an ultrahigh resolution gamma ray imaging detector. (E) Appositional ICE camera;

FIG. 2 depicts an illustrative embodiment of a prior art pinhole gamma camera;

FIG. 3 depicts an illustrative embodiment of components of an ICE-gamma camera;

FIG. 4 depicts an illustrative embodiment of a design of the ICE gamma camera depicted in FIG. 1. Left: components of the ICE gamma camera. Right: a cross sectional view of the micro pinhole camera elements;

FIG. 5 depicts an illustrative embodiment of (A) Schematic of a small animal SPECT system based on inverted compound eye (ICE) cameras. It has a total of ˜1440 micro-pinhole camera elements around the object. (B) Illustration of the angular sampling offering by an ICE-SPECT system for a single trans-axial slice of 100-μm thickness;

FIG. 6 depicts an illustrative embodiment of a method used in portions of ICE-camera systems of FIGS. 1B-1E and 3-5; and

FIG. 7 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for an inverted compound eye (ICE) camera. Other embodiments are described in the subject disclosure.

One or more aspects of the subject disclosure include an apparatus having a plurality of panels, where each panel is positioned at a different viewing angle of a target object, and where each panel senses a plurality of two-dimensional (2D) projections from fractional views of a volume of interest of the target object at a viewing angle corresponding to the panel. Each panel can have a plurality of apertures for receiving gamma rays from the plurality of fractional views of the volume of interest of the target object at the viewing angle corresponding to the panel, and a plurality of sensors aligned with the plurality of apertures for generating the plurality of 2D projections from the fractional views of the volume of interest of the target object at the viewing angle corresponding to the panel. That apparatus can further utilize a memory to store instructions, and a processor coupled to the plurality of panels and the memory to execute the instructions and perform operations including receiving, from each panel, the plurality of 2D projections of the fractional views of the volume of interest of the target object at the viewing angle corresponding to the panel, and generating, from the of 2D projections of the fractional views of the volume of interest provided by each panel, a first three-dimensional (3D) image of a first 3D section of the target object.

One embodiment of the subject disclosure includes a method for receiving, from each panel of a plurality of panels positioned at differing viewing angles of a target object, a plurality of 2D projections from fractional views of a volume of interest of the target object, wherein the plurality of 2D projections of fractional views provided by each panel are generated from a plurality of apertures and corresponding plurality of sensors used by each panel to sense gamma rays generated by the target object, and generating, from the plurality of 2D projections of the fractional views, a first 3D image of a first 3D section of the target object.

One embodiment of the subject disclosure includes a method for assembling a plurality of panels, where each panel is positioned at a different viewing angle of a target object, and where each panel is configured to sense a plurality of 2D projections from fractional views of a volume of interest of the target object at a viewing angle corresponding to one of the plurality of panels. Each panel can include a plurality of apertures for receiving gamma rays from the fractional views of the volume of interest of the target object, and a plurality of sensors aligned with the plurality of apertures for generating the plurality of 2D projections of the fractional views of the volume of interest of the target object. The method can further include assembling a controller for performing operations including receiving, from each panel, the plurality of 2D projections of the fractional views of the volume of interest of the target object at the viewing angle corresponding to the panel, and generating, from the plurality of 2D projections of the fractional views of the volume of interest provided by each panel, a first three-dimensional (3D) image of a first 3D section of the target object.

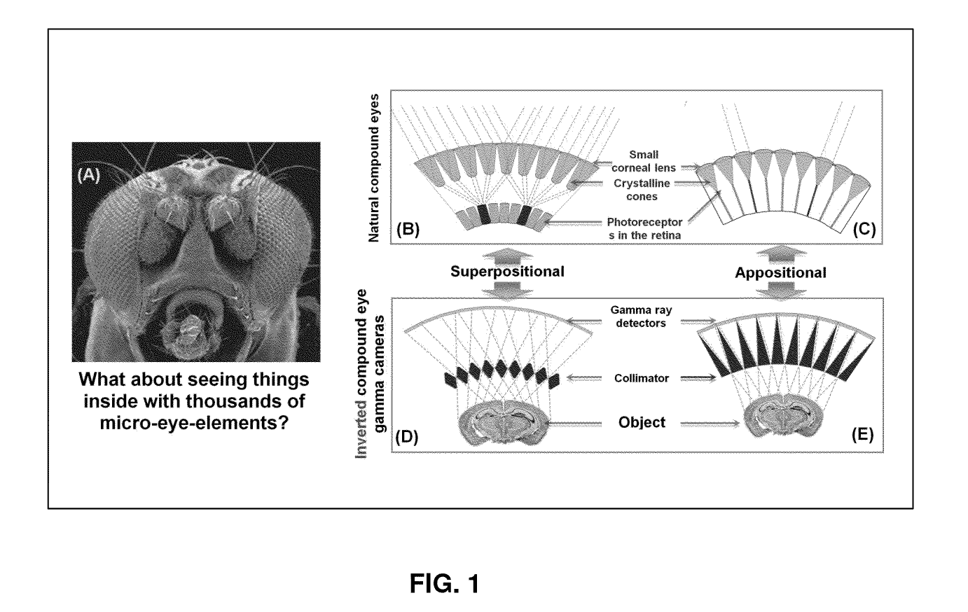

The subject disclosure describes a design of an inverted compound eyes (ICE) camera that is in part inspired by compound eyes often found on small invertebrates, such as flies and moths (see references J. S. Sanders, Ed., Selected Papers on Natural and Artificial Compound Eye Sensors (SPIE Milestone Series. Bellingham, Wash.: SPIE, 1996, p.̂pp. Pages; R. Volkel, M. Eisner, and K. J. Weible, “Miniaturized imaging systems,” Microelectronic Engineering, vol. 67-8, pp. 461-472, June 2003.; M. R. Descour, A. H. O. Karkkainen, J. D. Rogers, C. Liang, R. S. Weinstein, J. T. Rantala, et al., “Toward the development of miniaturized Imaging systems for detection of pre-cancer,” Ieee Journal of Quantum Electronics, vol. 38, pp. 122-130, February 2002; A. Bruckner, J. Duparre, F. Wippermann, P. Dannberg, and A. Brauer, “Microoptical Artificial Compound Eyes,” Flying Insects and Robots, pp. 127-142, 2009; K. H. Jeong, J. Kim, and L. P. Lee, “Biologically inspired artificial compound eyes,” Science, vol. 312, pp. 557-561, Apr. 28, 2006; J. W. Duparre and F. C. Wippermann, “Micro-optical artificial compound eyes,” Bioinspiration & Biomimetics, vol. 1, pp. R1-R16, March 2006—all of which are incorporated herein by reference in their entirety). An ICE camera can comprise a large number of independent micro-pinhole-gamma-camera-elements closely packed in a dense array (e.g. 10-20 independent camera-elements per cm²). Each of the micro-camera-elements (MCEs) covers a narrow solid angle through a target object (as shown by way of illustration in FIG. 1).

A SPECT system constructed from multiple ICE cameras would have a very large number (up to several thousand) of micro-camera-elements (MCE) in the system pointing towards the target object and collecting gamma rays simultaneously. An embodiment such as this can achieve a substantially high detection efficiency, while still allowing for an exceptional imaging resolution.

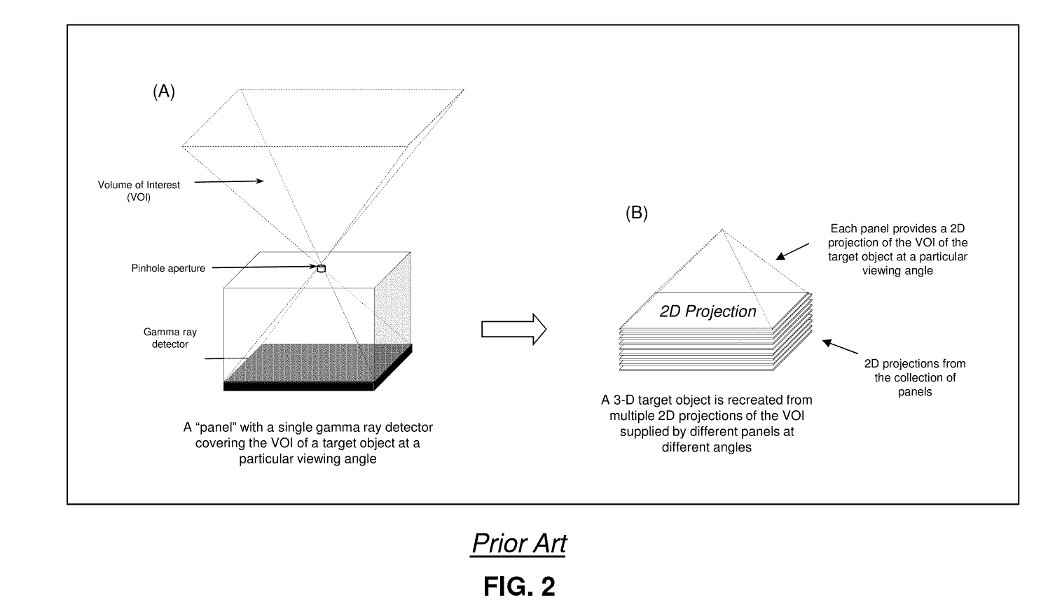

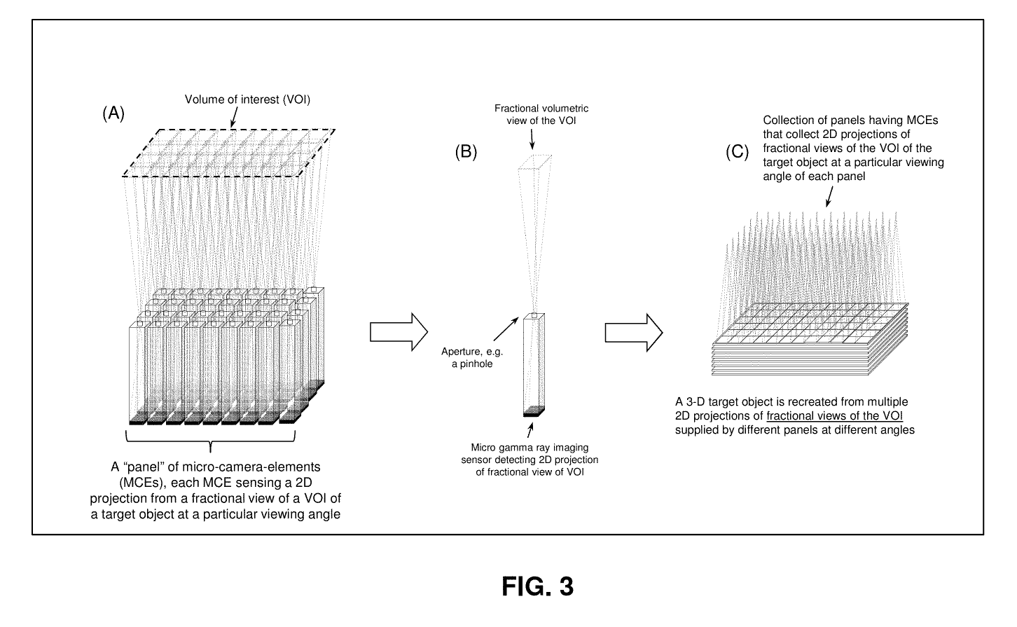

Distinctions between an ICE camera and a regular pinhole gamma camera are illustrated in FIGS. 2-3. Typical pinhole cameras (see prior art system of FIG. 2), such as the one used in a U-SPECT-II system, consist of a gamma ray detector coupled to a single pinhole or multiple pinhole aperture, which are designed to cover an entire volume-of-interest (VOI). As noted in FIG. 2A, gamma rays from a volumetric portion of a target object are received via a pinhole aperture and detected by a gamma ray detector. In a U-SPECT-II system, it is common for the system to have multiple detectors such as shown in FIG. 2A at various viewing perspectives. Each of these detectors in turn produces a collection of two-dimensional (2D) projections at differeing viewing angles as depicted in FIG. 2B. Each 2D projection shown in FIG. 2A is produced from a conical view of the VOI of the target object at different angles.

By comparison, an ICE camera consists of a large number of micro-camera-elements (MCEs) as shown in FIGS. 1 and 2. Each MCE is essentially an independent and highly miniturized gamma camera. Each MCE is designed to cover only a narrow conical volume through the VOI of the target object, thereby enabling the camera of the MCE to capture a 2D projection of gamma rays received from a fractional view of the VOI at the viewing angle of the MCE. An ICE camera utilizes a large number of MCEs to cover fractional views of the VOI, as illustrated in FIG. 3A. FIG. 3B depicts a single MCE and the 2D projection captured from the fractional conical volumetric view of the VOI of the target object. For illustration purposes, the collection of MCEs is referred to in FIG. 3A as a “panel” of MCEs, each MCE capturing 2D projections of gamma rays from the fractional views of the VOI of the target object at a particular viewing angle corresponding to the panel. A 3D image of the target object can be reconstructed from each panel from the collection of 2D projections of fractional views of the VOI of the target object provided by the MCEs of each panel—see FIG. 3C. By positioning several panels of MCEs at differing viewing angles of a target object, the collection of MCEs provides sufficient image data to construct a 3D image of the target object with substantially higher resolution than prior art systems such as the U-SPECT.

Why a compound eye (ICE) camera design offer a dramatically improved imaging performance over conventional pinhole cameras for SPECT imaging? As highlighted in FIG. 2, ICE camera design allows one to share the duty of collecting photons across a very large number of micro camera elements (MCEs). This brings two key benefits.

A SPECT system based on ICE cameras such as shown in FIG. 3 can offer a dramatically improved sensitivity (by 1-2 orders of magnitude) over current state-of-the-art SPECT systems utilizing regular gamma cameras. Additionally, to image the same field-of-view (FOV) at a comparable imaging resolution, a SPECT system based on ICE cameras can be constructed with a greatly reduced physical dimension over a conventional SPECT system design. Since each MCE only needs to cover a very small solid angle, it can be designed with very small physical dimensions, e.g. ˜2 mm wide and a few centimeters tall. One can use a large number of MCEs together to form an ICE camera as shown in FIG. 3 with an overall dimension of the ICE camera being very compact when compared to prior art systems.

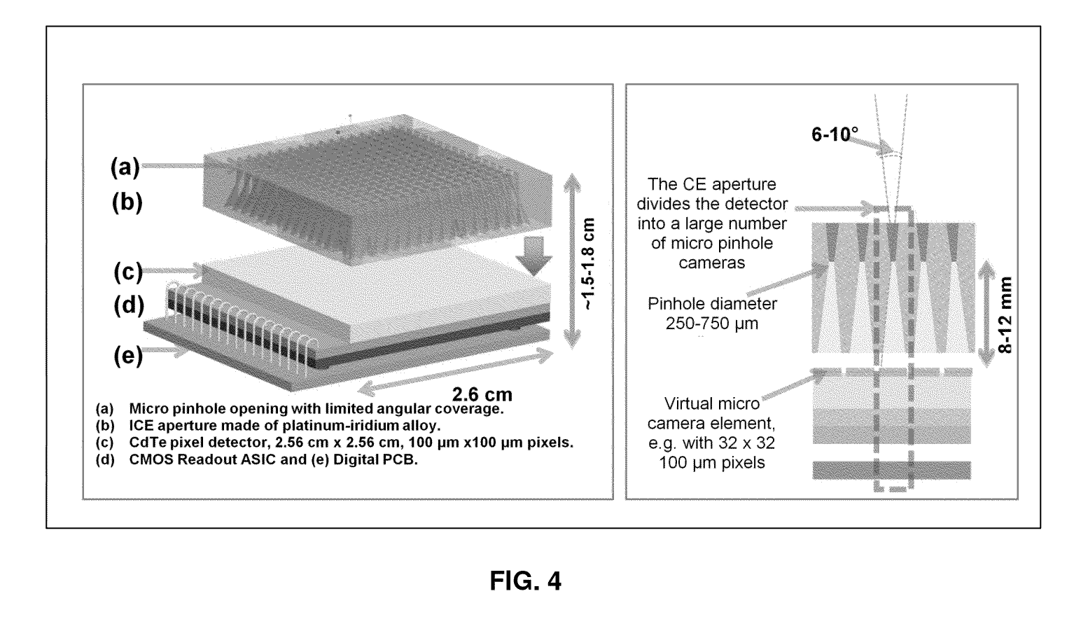

A compound eye gamma camera such as has been illustrated in FIG. 3 can be constructed with position sensitive gamma ray detectors and special collimation aperture as shown in FIG. 4. Such a design can use ultrahigh resolution imaging detectors, such as semiconductor pixel detectors (as shown in FIG. 4), or high resolution scintillation detectors (see S. Salvador, M. A. N. Korevaar, J. W. T. Heemskerk, R. Kreuger, J. Huizenga, S. Seifert, et al., “Improved EMCCD gamma camera performance by SiPM pre-localization,” Physics in Medicine and Biology, vol. 57, pp. 7709-7724, Nov. 21, 2012; and L. J. Meng, “An intensified EMCCD camera for low energy gamma ray imaging applications,” Ieee Transactions on Nuclear Science, vol. 53, pp. 2376-2384, August 2006, each of which is incorporated herein by reference in its entirety.

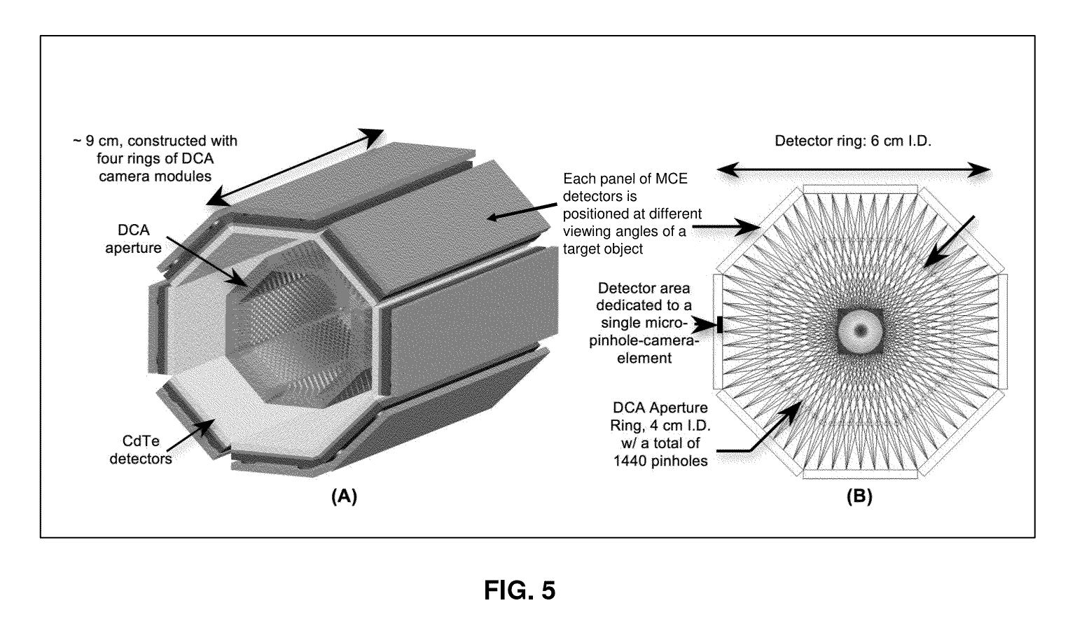

A SPECT system can be constructed using multiple ICE cameras as illustrated in FIG. 5. A design such as shown in FIG. 5 has the potential of offering more than an order of magnitude improvement in sensitivity over the current state-of-art commercial small animal SPECT systems. A SPECT system based on ICE cameras (ICE-SPECT) may achieve an imaging resolution level similar to those offered by commercial pre-clinical Positron Emission Tomography (PET) imaging system (e.g. 1 mm) The ICE-SPECT approach can offer a detection efficiency of ˜5% or higher, which approaches the sensitivity offered by its PET counterpart.

The projection data collected by all the micro-camera-elements (MCEs) can be combined to form 3-D images of the object volume using several image reconstruction techniques, such as maximum likelihood (ML), penalized maximum likelihood or equivalently maximum a posteriori (MAP) algorithms. The subject disclosure below provides a brief conceptual description of these techniques.

Let the target object volume being imaged be represented by a series of unknown pixel intensities x=[x₁, x₂, . . . , x_{N}]^{T} that are underlying the measured projection data y=[y₁, y₂, . . . , x_{M}]^{T}. The mapping from x to y is governed by a probability distribution function, pᵣ(y;x). For emission tomography, y can be approximated as a series of independent random Poisson variables, whose expectations are given by

$${\overline{y}}_{m} ≡ E [ {y}_{m} ] = {\sum }_{{y}_{m} = 0}^{∞} {y}_{m} \cdot {p}_{r} ( {y}_{m ; x} ) m = 1 , … , M , \qquad ( 1 )$$

or by the following discrete transform

y̅=T· p̅,

and

p̅=A·x. (2)

E[·] denotes the expectation operator. T is the total imaging time. p̅ is the mean projection with a unit imaging time. A is a M×N matrix that represents the discretized system-response function (SRF). If it is assumed that the SRF is free of systematic error, the log-likelihood function of the measured data y can be given by

$$\begin{matrix}L ( x , y ) ≡ log {p}_{r} ( y ; x ) = {\sum }_{m} {y}_{m} log {\overline{y}}_{m} - {\overline{y}}_{m} , \\ and & ( 3 ) \\ {\overline{y}}_{m} = T \cdot {\sum }_{m} {a}_{mn} {x}_{n} , & ( 4 )\end{matrix}$$

where aₘₙ is an element of A. This formula provides the probability of a gamma ray emitted at the n'th source voxel being detected by the m'th detector pixel within a unit imaging time. The underlying image function may be reconstructed as

$$\{ \begin{matrix} {\hat{x}}_{PML} ( y ) = {argmax}_{x \geq 0} [ L ( x , y ) - β \cdot R ( x ) ] \\ and then \\ {\hat{x}}_{PF \text{-} PML} = {F}_{filter} \cdot {\hat{x}}_{PML} ( y ) ,\end{matrix} \qquad ( 5 )$$

where R(x) is a scalar function that selectively penalizes certain undesired features in reconstructed images. β is a parameter that controls the degree of regularization. F_{filter} is an N×N matrix that represents the post-filtering operator.

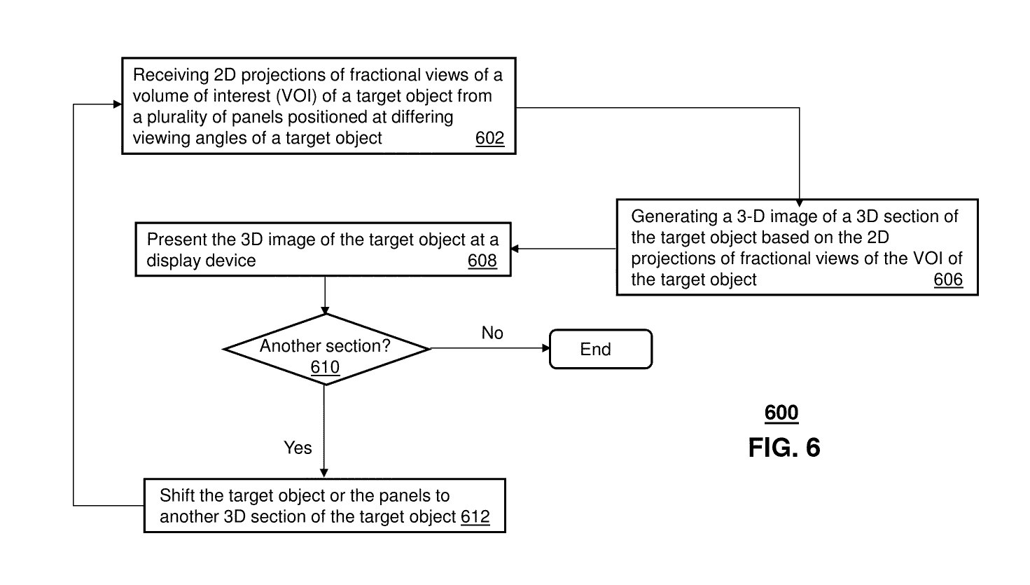

FIG. 6 depicts an illustrative embodiment of a method 600 used in portions of the ICE-SPECT systems described in FIGS. 1B-1E and 3-5. Method 600 can begin with step 602 where a computing device such as a computer system receives from each panel 2D projections from fractional views of a VOI of a target object. The target object may be a biological object or an inanimate object. As noted above, a 2D projection of a fractional view of the VOI comes from an MCE such as shown in FIG. 3B, which is part of a panel of many MCEs, as depicted in FIGS. 3A and 3C, that collect 2D projections from the fractional views of the VOI of the target object. Each panel is positioned at a particular viewing angle of the target object as shown in FIGS. 5A-5B. Depending on tolerances in the construction of the panels and the MCEs, some of the MCE's may detect 2D projections of fractional views of the VOI that overlap with other MCEs. Similarly, some panels may collectively detect gamma rays from other panels depending on their respective viewing angles. Accordingly, some of the 2D projections of the fractional views of the VOI captured by a panel may overlap with the 2D projections captured by one or more other panels.

At step 606, the computing device can generate a 3D image of a specific 3D section of the target object using all or a subset of the 2D projections of the fractional views of the VOI of the target object provided by each panel at step 602. Step 606 can be performed by the computing device according to image processing algorithms such as those described above or variants thereof.

At step 608, the 3D image produced in step 606 can be presented in a display device coupled to the computing device. If analysis of another 3D section of the target object is requested at step 610 by the operator, the target object can be shifted in step 612 relative to the panels of the ICE-SPECT while the panels are held in a fixed positioned, or the panels can be shifted relative to the target object while the target object is held in a fixed position. The shifting of the target object or the panels can be performed by an electro-mechanical device (not shown in the figures) controlled by the computing device. The electro-mechanical device can be, for example, a mechanism of gears, slideable components, and/or other mechanical components controlled by a motor (e.g., a linear motor) that shifts the target object or the panels to perform analysis of other sections of the target object with the ICE-SPECT as described above. The operator of the computing device can be presented a user interface at the display of the computing device to request that the target object or panels be moved to a new section of the target object by a given distance for further analysis. Such a request can invoke step 612 which performs the displacement followed by another iteration of the process of capturing images of the target object according to the steps previously described for method 600. If the operator does not request additional analysis of the target object at step 610, then the process ends as shown in FIG. 6.

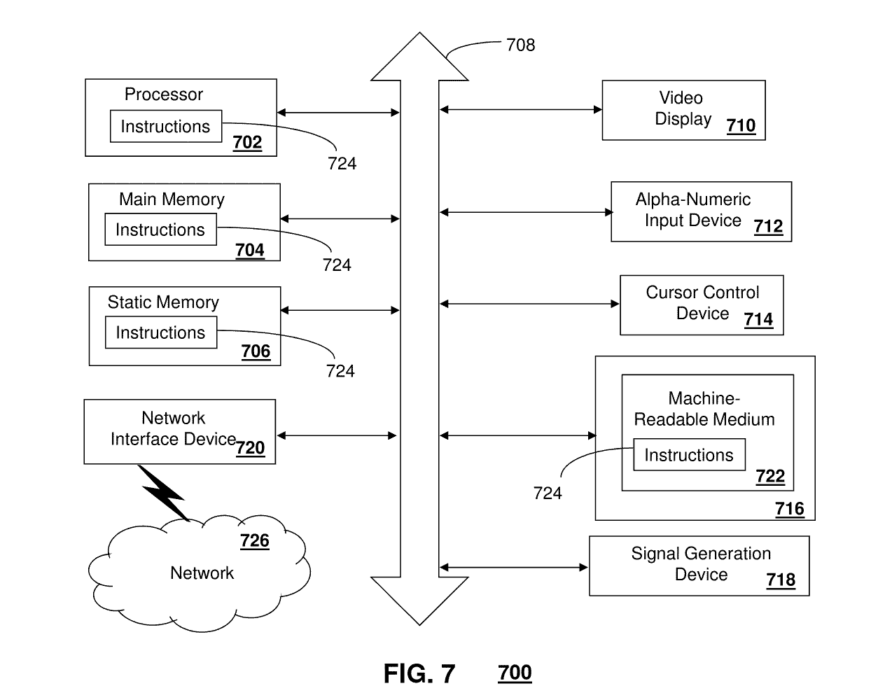

FIG. 7 depicts an exemplary diagrammatic representation of a machine in the form of a computer system 700 within which a set of instructions, when executed, may cause the machine to perform any one or more of the methods described above. In some embodiments, the machine may be connected (e.g., using a network 726) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 700 may include a processor (or controller) 702 (e.g., a central processing unit (CPU)), a graphics processing unit (GPU, or both), a main memory 704 and a static memory 706, which communicate with each other via a bus 708. The computer system 700 may further include a display unit 710 (e.g., a liquid crystal display (LCD), a flat panel, or a solid state display). The computer system 700 may include an input device 712 (e.g., a keyboard), a cursor control device 714 (e.g., a mouse), a disk drive unit 716, a signal generation device 718 (e.g., a speaker or remote control) and a network interface device 720. In distributed environments, the embodiments described in the subject disclosure can be adapted to utilize multiple display units 710 controlled by two or more computer systems 700. In this configuration, presentations described by the subject disclosure may in part be shown in a first of the display units 710, while the remaining portion is presented in a second of the display units 710.

The disk drive unit 716 may include a tangible computer-readable storage medium 722 on which is stored one or more sets of instructions (e.g., software 724) embodying any one or more of the methods or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 722 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 700.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure. In one or more embodiments, features that are positively recited can also be excluded from the embodiment with or without replacement by another component or step. The steps or functions described with respect to the exemplary processes or methods can be performed in any order. The steps or functions described with respect to the exemplary processes or methods can be performed alone or in combination with other steps or functions (from other embodiments or from other steps that have not been described).

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus, comprising:
a plurality of panels, wherein each panel is positioned at a different viewing angle of a target object, wherein each panel senses a plurality of two-dimensional (2D) projections from fractional views of a volume of interest of the target object at a viewing angle corresponding to the panel, and wherein each panel comprises:
a plurality of apertures for receiving gamma rays from the fractional views of the volume of interest of the target object at the viewing angle corresponding to the panel;
a plurality of sensors aligned with the plurality of apertures for generating the plurality of 2D projections from the fractional views of the volume of interest of the target object at the viewing angle corresponding to the panel;
a memory to store instructions; and
a processor coupled to the plurality of panels and the memory, wherein responsive to executing the instructions, the processor performs operations comprising:
receiving, from each panel, the plurality of 2D projections of the fractional views of the volume of interest of the target object at the viewing angle corresponding to the panel; and
generating, from the plurality of 2D projections of the fractional views of the volume of interest provided by each panel, a first three-dimensional (3D) image of a first 3D section of the target object.

2. The apparatus of claim 1, wherein the generating of the 3D image comprises generating the 3D image according to a subset of the plurality of 2D projections of the fractional views provided by each panel.

3. The apparatus of claim 1, wherein the plurality of 2D projections of the fractional views of the volume of interest received from each panel is a subset of a total number of 2D projections received by each panel.

4. The apparatus of claim 1, wherein, for at least one of the plurality of panels, at least two of the plurality of 2D projections of the fractional views of the volume of interest overlap at least in part with each other.

5. The apparatus of claim 1, wherein at least two of the panels have viewing angles of the target object that overlap at least in part with each other.

6. The apparatus of claim 1, wherein, for at least one of the plurality of panels, each of the fractional views of the volume of interest has a tapered volumetric shape.

7. The apparatus of claim 1, comprising a mechanism for repositioning the target object, wherein the operations of the processor further comprise repositioning the target object relative to the plurality of panels for capturing a second three-dimensional image of the target object at a second three-dimensional section of the target object.

8. The apparatus of claim 1, comprising a mechanism for repositioning the plurality of panels, wherein the operations of the processor further comprise repositioning the plurality of panels relative to the target object for capturing a second three-dimensional image of the target object at a second three-dimensional section of the target object.

9. A method, comprising:
receiving, from each panel of a plurality of panels positioned at differing viewing angles of a target object, a plurality of two-dimensional (2D) projections from fractional views of a volume of interest of the target object, wherein the plurality of 2D projections of the fractional views provided by each panel are generated from a plurality of apertures and corresponding plurality of sensors used by each panel to sense gamma rays generated by the target object; and
generating, from the plurality of 2D projections of the fractional views provided by each panel, a first three-dimensional image of a first three-dimensional section of the target object.

10. The method of claim 9, wherein, for each panel, the plurality of sensors are aligned with the plurality of apertures for generating the plurality of 2D projections of the fractional views of the volume of interest of the target object.

11. The method of claim 9, wherein the generating of the 3D image comprises generating the 3D image according to a subset of the plurality of 2D projections of the fractional views provided by each panel.

12. The method of claim 9, wherein the plurality of 2D projections of the fractional views of the volume of interest received from each panel is a subset of a total number of 2D projections received by each panel.

13. The method of claim 9, wherein, for at least one of the plurality of panels, at least two of the plurality of 2D projections of the fractional views of the volume of interest of the target object overlap at least in part with each other.

14. The method of claim 9, wherein at least two of the panels have viewing angles of the target object that overlap at least in part with each other.

15. The method of claim 9, wherein, for at least one of the plurality of panels, each of the fractional views of the volume of interest has a tapered volumetric shape.

16. The method of claim 9, further comprising repositioning the target object relative to the plurality of panels or repositioning the plurality of panels relative to the target object to capture a second three-dimensional image of the target object at a second three-dimensional section of the target object.

17. The method of claim 9, wherein the target object comprises a biological organism.

18. A method, comprising:
assembling a plurality of panels, wherein each panel is positioned at a different viewing angle of a target object, wherein each panel is configured to sense a plurality of two-dimensional (2D) projections from fractional views of a volume of interest of the target object at a viewing angle corresponding to one of the plurality of panels, and wherein each panel comprises a plurality of apertures for receiving gamma rays from the fractional views of the volume of interest of the target object, and a plurality of sensors aligned with the plurality of apertures for generating the plurality of 2D projections of the fractional views of the volume of interest of the target object;
assembling a controller for performing operations comprising:
receiving, from each panel, the plurality of 2D projections of the fractional views of the volume of interest of the target object at the viewing angle corresponding to the panel; and
generating, from the plurality of 2D projections of the fractional views of the volume of interest provided by each panel, a first three-dimensional (3D) image of a first 3D section of the target object.

19. The method of claim 18, wherein at least two of the panels have viewing angles of the target object that overlap at least in part with each other.

20. The method of claim 18, further comprising assembling a mechanism for repositioning the target object relative to the plurality of panels or for repositioning the plurality of panels relative to the target object to capture a second three-dimensional image of the target object at a second three-dimensional section of the target object.
